(19) United States
(12) Patent Application Publication
(10) Pub. No.: US 2017/0091798 A1
(43) Pub. Date: Mar. 30, 2017

(54) SPORTS-BASED REWARDS SYSTEM, METHOD AND APPARATUS

(71) Applicant: NTN Buzztime, Inc., Carlsbad, CA (US)

(72) Inventors: Robert Burnett, Carlsbad, CA (US); Tim Tembreull, Carlsbad, CA (US); David Friedland, San Diego, CA (US); Troy Molander, San Marcos, CA (US); Eric Bower, Addison, TX (US)

(21) Appl. No.: 14/866,868

(22) Filed: Sep. 26, 2015

(51) Int. Cl. G06Q 30/02; A63F 13/35

(52) U.S. Cl. CPC G06Q 30/0209; A63F 13/35

(57) ABSTRACT

Disclosed are a system, method and apparatus for implementing a sports-based reward program. In one embodiment, a server provides future sporting event information, pre-game questions, and in-game questions to users over a wide-area network. The users provide predictions to the pre-game and in-game questions for one or more selected sporting events. The server tracks the predictions to determine whether they actually occur during the selected sporting event(s), and provides a credit to each user who makes accurate predictions. Users may then purchase goods and services using the credits.

### BACKGROUND

I. Field of Use

The present application relates generally to in-venue entertainment and rewards programs. More specifically, the present application relates to an interactive, sports-based rewards system, method and apparatus for driving sales in venues such as sports bars.

II. Description of the Related Art

Public venues such as sports bars are always searching for new ways to attract and retain customers. An important goal for these venues is to keep patrons within the premises for as long as possible, hoping that more goods and services will be purchased. In the past, some venues have offered onsite gaming for this purpose. For example, electronic trivia has been offered for many years, allowing onsite patrons to answer trivia questions using a wireless device, often provided to them by the venue. Players typically play alone or in teams against other players in the venue, or against individuals and/or teams playing in other venues. Providing enjoyable onsite gaming increases the time spent by patrons at such venues, resulting in higher sales and profits.

Rewards programs have also been used in the past to try to retain customer loyalty and drive sales. Such programs typically award patrons credits or coupons when they purchase certain goods and services for use in future purchases.

More recently, sports-based electronic games have been introduced, particularly suited for sports bars. Some of these games may rely on a live video feed of a sporting event, such as a game where patrons are asked to guess what the next play of a professional football game will be. Players enter their selections prior to the snap, and points may be awarded to patrons who guess correctly.

While live, sports-based games described above may be popular, they suffer from several drawbacks. The primary one being that in order to play such a game and be competitive with other players, one must pay strict attention to the game and interact with the game generally every minute or so. This causes “tunnel vision” and may cause patrons to become unsocial and may actually result in a drop in sales, as patrons focus on the game and not on ordering food and beverages.

It would be desirable to provide sports-based entertainment to patrons as part of a rewards program without having patrons focus entirely on action occurring during games.

### SUMMARY

The embodiments described herein relate to a system, device, and methods for implementing a sports-based rewards program. In one embodiment, a server is described, comprising a communication interface for receiving future sporting event information and real-time sporting event information, the future sporting event information related to one or more sporting events that will occur in the future, and the real-time sporting event information relating to events that occur during one or more sporting events as the sporting events are being played, a network interface for communicating with a plurality of network-enabled devices, a database for storing account information related to one or more users of the network-enabled devices, a memory for storing processor-executable instructions, and a processor for executing the processor-executable instructions. The processor-executable instructions cause the server to receive the future sporting event information via the network interface, provide the future sporting event information to users of the plurality of network-enabled devices via the network interface, receive a selected sporting event from one of the network-enabled devices, the selected sporting event chosen by the user from one of the one or more sporting events that will occur in the future, in response to receiving the selected sporting event, provide a pre-game question to the network-enabled device via the network interface prior to commencement of the selected sporting event, the pre-game question related to an outcome of the selected sporting event, receive a pre-game prediction to the pre-game question from the mobile device via the network interface, the pre-game prediction indicative of a prediction, by the user, of the outcome related to the pre-game question. store the pre-game prediction in association with the user in the database, receive the real-time sporting event information via the network interface as the one or more sporting events occur, including the selected sporting event, determine whether the outcome of the selected sporting event matches the pre-game prediction from the user, and provide a credit to an account associated with the user when the outcome of the selected sporting event marches the pre-game prediction, the credit for redemption by the user at a venue.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates one embodiment of an inter-active sports-based rewards system used to drive sales for venues such as bars, nightclubs, taverns, and other social gathering places;

FIG. 2 illustrates one embodiment of a presentation of future sporting event information on one of the network-enabled devices shown in FIG. 1;

FIG. 3 is a functional block diagram of one embodiment of one of the network-enabled devices shown in FIGS. 1 and 2;

FIG. 4 is a functional block diagram of one embodiment of the server shown in FIG. 1 for implementing a sports-related rewards program; and

FIG. 5 is a flow diagram illustrating one embodiment for implementing a sports-based rewards program, as performed by the server shown in FIGS. 1 and 4.

### DETAILED DESCRIPTION

The present application relates to embodiments for proving an electronic, inter-active sports-based rewards system, method and apparatus, used to drive sales for venues such as bars, taverns, and other social gathering places. Patrons of such venues may choose to participate in such an interactive sports-based rewards system by accessing a server via a network-enabled device, such as a tablet computer or smart phone. The server provides information relating to sporting events that will occur in the future. Patrons may select one or more of the future sporting events and in response, the server provides one or more pre-game questions relating to one or more outcomes of the selected sporting event(s). In some embodiments, two or more predication choices are provided in association with each pre-game question to present the sports-related game to patrons in a multiple-choice format. Patrons answer the pre-game question(s) and provide their predictions back to the server, where they are stored for later evaluation against outcomes that actually occur later when the selected sporting event(s) have concluded. Further, during selected sporting events, patrons may be asked additional, “in-game” questions relating to events that may occur during predefined portions of the selected sporting event(s). Predictions to the in-game questions are similarly provided to the server, where they are stored. As the selected sporting event(s) are played, the server automatically evaluates the predictions against real-time sporting event information related to the selected sporting event(s) to determine whether the predictions from the patrons have occurred or not. If so, patrons are awarded rewards points in an account associated with one or more participating venues for use by patrons to receive discounts on food, beverages, and/or other merchandise or services. A leaderboard may be presented to patrons to inform them of high-scoring patrons and/or teams.

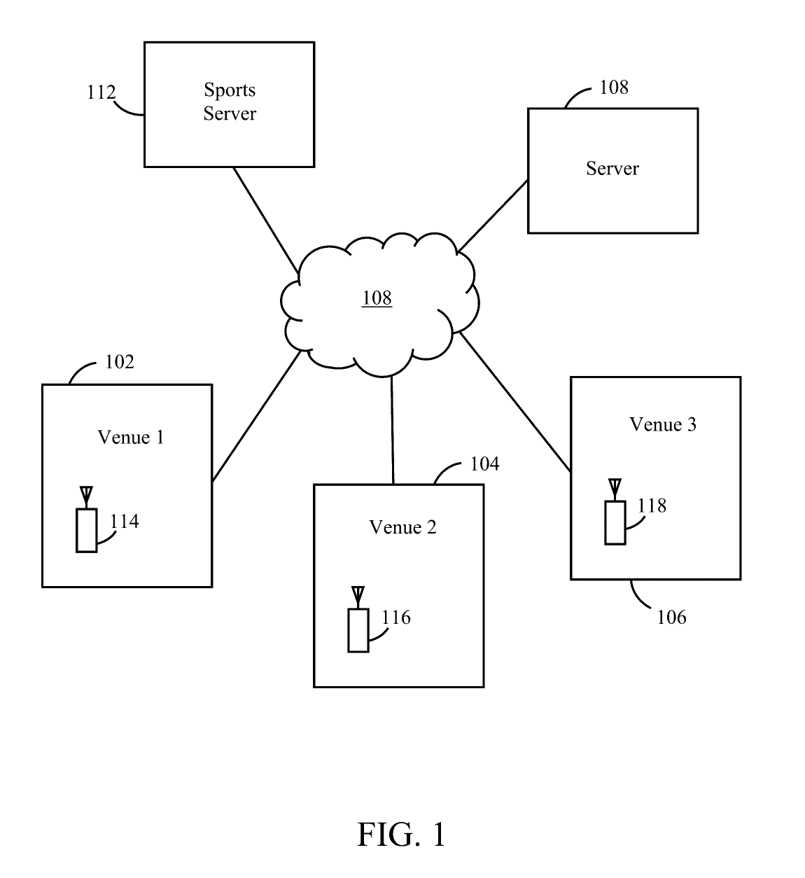

FIG. 1 illustrates one embodiment of an interactive sports-based rewards system 100 used to drive sales for venues such as bars, nightclubs, taverns, and other social gathering places. Shown are venues 102, 104, and 106, server 108, wide-area network 110, and sports server 112. Server 108 is coupled to each of the venues 102, 104, and 106 via wide-area network 110, which comprises one or more of the Internet, cellular data networks, satellite data networks, fiber-optic networks, and/or other information networks capable of enabling communications over large distances. Wide-area network 110 comprises circuitry and related software to allow high-speed data communications between/among the various entities shown in FIG. 1, as is generally known in the art. Each of the venues 102, 104, and 106 typically operate a local area network, comprising a local server (not shown) and wireless access point(s) (also not shown), such as a wireless router/gateway device. Each local-area network allows patrons of each venue to access server 108 in order to participate in the interactive sports-based rewards system 100. In one embodiment, access to server 108 is restricted to only onsite access, i.e., using a venue's local-area network. Such access is provided via network-enabled devices, such as smart phones, tablet computers, desktop computers, laptop computers, or any other device capable of communication over one or more data networks, shown in FIG. 1 as devices 114, 116, and 118. In other embodiments, access to server 108 is allowed outside of the venues using personal or public networks, such as personal or public Wi-fi networks, cellular data networks, or other data networks. In still other embodiments, access to server 108 may be allowed for portions of the interactive sports-based rewards system while restricted to in-venue access during other portions, as will be explained later herein.

A user of a network-enabled device begins an interaction with server 108 by visiting a web page offered by server 108 or via a software application downloaded to the user's network-enabled device. In any case, the user may login to a pre-existing account via server 108 or set up a new account if the user has not registered with server 108 previously. Account information may be stored in a database associated with server 108 or it may be stored in association with one or more of the venues, for use in redeeming “rewards points” or credits earned by playing the interactive sports-based rewards system, as explained later herein.

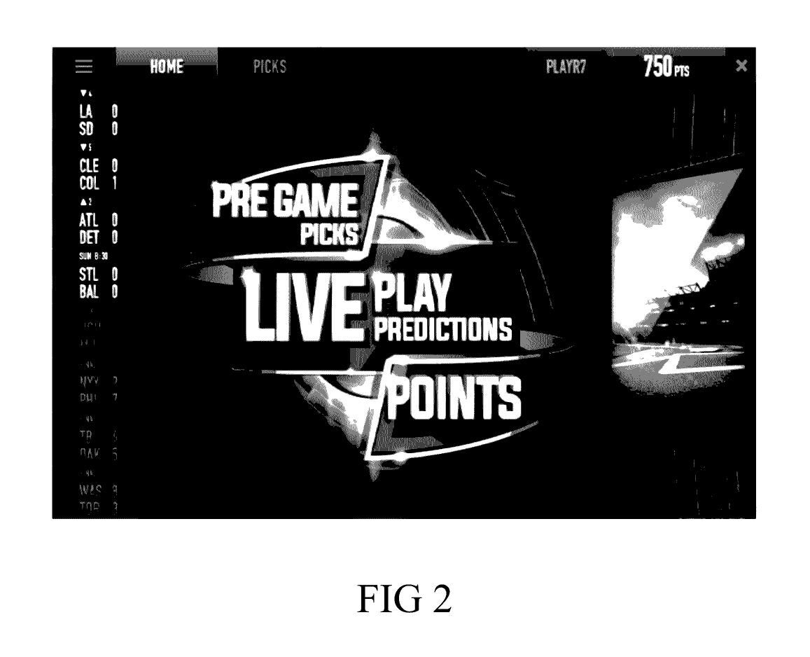

After a user has logged onto or created an account, server 108 may provide “future sporting event information” to the user in the form of a list or other visual presentation of a number of sporting teams that will be playing against each other sometime in the future. The number of future “match-ups” may be filtered by team name, venue, city, start time, sport type (i.e., football games, baseball games, basketball games, etc.), etc. FIG. 2 is one embodiment of such a presentation of future sporting event information. In one embodiment, the future sporting event information is obtained from sports server 112, shown in FIG. 1 as being coupled either directly or indirectly via wide-area network 110 to server 108. Sports server 112 comprises a sporting event information distribution center, or more generally a data collection and distribution center, typically owned and operated by a third party, that provides sporting information from a wide variety of different sports, to customers such as server 108. The sporting information may be provided, for example, as a subscription-based service, wherein the information may be provided, for example, in a series of XML files. The sporting information may comprise future team match ups (e.g., a list of teams playing against other teams) in a variety of sports, team or individual player statistics (such as team standing, win/loss percentage, batting averages, completion percentages, average rushing yards per game, field goal percentages, etc.). This information is provided to server 108 for use by server 108 to generate the future sporting event information. Match ups may be displayed for games occurring minuets, hours, days, weeks or even months into the future

Sever 108 receives the sporting information from sports server 112, decodes it if necessary, and generates the future sporting event information from that information. The future sporting event information is then provided to users, either directly to the users' network-enabled devices and/or to other devices, such as one or more display monitors (for example, a number of TV monitors for viewing at any of the venues in FIG. 1).

Users may select one or more future sporting events (i.e., individual or team match-ups), typically by touching a touch-sensitive display screen on the users' network-enabled device. The users' selections are sent back to server 108, where, in response, server 108 provides one or more “pre-game” questions to the user for each sporting event chosen prior to commencement of each of the selected sporting events. Pre-game questions comprise questions posed to the user prior to commencement of users' selected sporting events, i.e., before the start of a game between two teams or opponents. The questions relate to certain “outcomes” of the selected sporting event, either on a team level or an individual level. For example, one outcome of two teams playing against each other is the winner of the game. Another outcome could be defined as a team that scored the most field goals during the game. Another outcome could be defined as an action or “play” that occurs first in a game. Thus, the question(s) posed to the user may comprise, “Which team will win the game?”, “Which team will have the most field goals?”, and “Which type of play will happen first?” respectively. Of course, the pre-game questions are almost limitless.

The pre-game questions may be randomly selected by server 108 from a plurality of pre-game questions stored in a database, or they may be manually selected by on operator of server 108.

In one embodiment, each question is associated with two or more potential answers, responses, or predictions, for example, multiple-choice predictions for users to select. In other embodiments, users may enter their own predictions to the pre-game questions.

Each of the users' predictions are provided to server 108, where they are stored for future determination of whether the predictions were accurate or not.

Server 108 monitors the real-time sports-related information from sports server 112 to determine when each selected sporting event begins. In one embodiment, when server 108 determines that a selected sporting event has begun, server 108 may provide one or more “in-game” questions to users who previously provided pre-game predictions and/or any other users who wish to participate in the interactive sports-based rewards system as a sporting event occurs. The in-game questions are questions posed to users, asking users to predict an action or event that may occur during a first portion of a selected sporting event, such as an inning, half-inning, or a number of innings in a game of baseball, or during possession of a football or “drive”, a quarter, half, or even an entire game of football. In some cases, pre-game questions can be the same as in-game questions.

For example, during a baseball game, server 108 may determine that the game has started form the sporting information from server 112. At the top of the first inning, an in-game question may be provided by server 108 to users in the form of a question asking users to predict an action that will occur during the top half of the inning. In one embodiment, the question is associated with two or more prediction choices for users to select, such as, in this example, “Home Run”, “Walk”, “Double Play” and “Strikeout”. Each of these prediction choices may be assigned a point value by server 108. In football, the question may ask users to predict the result of a possession or drive, such as “Touchdown”, “Field Goal”, “Fumble”, “Interception”, and so on.

In one embodiment, the point value assigned to various predictions is proportional to the likelihood of a particular prediction occurring, either based on historical statistical averages, and/or based on events or actions that have occurred during the selected game. For example, in baseball, the general odds of a home run being hit by an “average” player may be 1 in 25, and server 108 may assign a point value of “100” to a home run prediction. However, during a team's first “at bat” in the first inning, the best hitters are often placed first in the lineup. On this basis alone (top of the lineup), server 108 may dynamically adjust the “normal” point value for a home run prediction down to, for example, 75, to account for the greater actual odds of a home run occurring at the top of the lineup. The dynamic adjustment by may also be based on actual players batting averages, slugging percentage, or one or more actual player statistics. Thus, server 108 may take into account a number of factors when assigning point values to predictions, based on information available to server 108 from sports server 112 or general statistical information. The point values may be adjusted either prior to the start of a selected sporting event or even as the game is being played, in some embodiments, by taking into consideration events that have occurred during the game, such as a player having struck out twice against a certain pitcher, a running play in football by a running back who is about to achieve a certain milestone number of rushing yards, etc.

In one embodiment, after presentation of in-game questions on users' network-enabled devices, a count-down timer is displayed to allow users only a predetermined time limit to respond to such in-game questions, such as 30 seconds.

At the conclusion of the game portion (i.e., inning, half-inning, possession, etc.), server 108 determines how many times the prediction occurred for each user participating in the interactive sports-based rewards system, and awards a credit based on the number of times that the action identified by the in-game prediction occurred during the game portion. In another embodiment, a credit is awarded immediately each time after a correctly-predicted action occurs during the game portion. In one embodiment, the credit is based on an original value multiplied by a number of times that the action occurred during the game portion.

After a number of credits have been accumulated by a user, the credits may be redeemed at certain of the venues shown in FIG. 1 to purchase food, beverage, or other items from one of the venues. For example, a user located inside venue 114 may select a “Rewards” tab on the display, where one or more rewards may be shown, such as a number of credits needed to “purchase” an item. A user may select one of the rewards by touching the display in the location of the displayed reward. In response, the network-enabled device may transmit a signal to an in-venue server to order the item and alert a waitperson that the item has been ordered, so it may be delivered to the user. The signal may comprise a location identifier for a waitperson to know where to deliver the item, such as a table number. An indication of the signal may also be provided to server 108, or to a server associated with venue 114, in order to reduce the user's credits in an amount equal to the credits used to “purchase” the item.

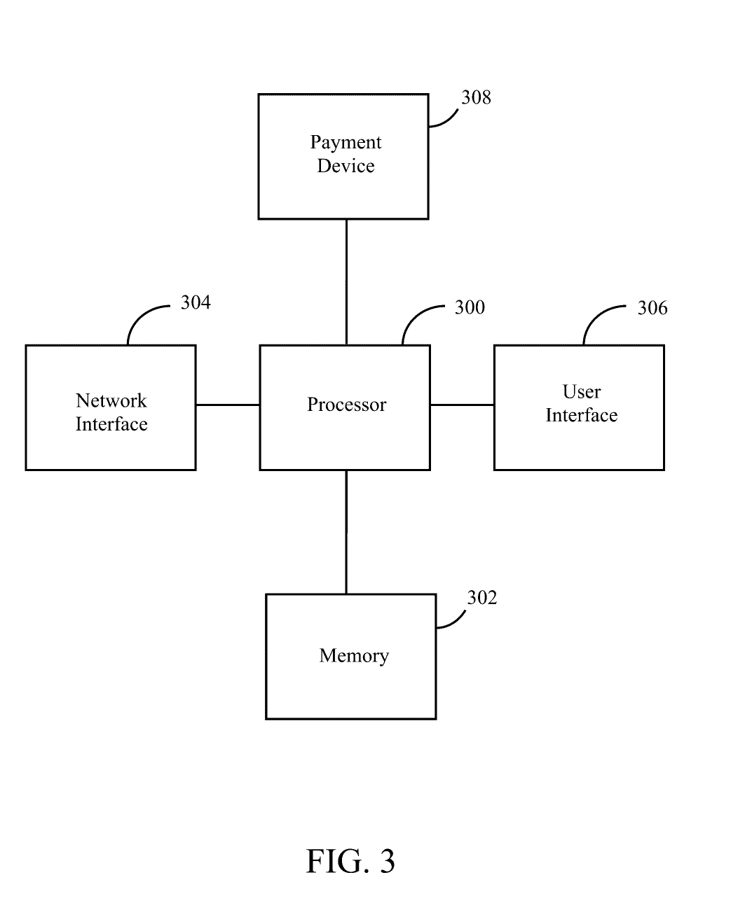

FIG. 3 is a functional block diagram of one embodiment of a network-enabled device. Specifically, FIG. 3 shows processor 300, memory 302, network interface 304, user interface 306, and optional payment device 308. It should be understood that the functional blocks may be connected to one another in a variety of ways and that not all functional blocks necessary for operation of the device are shown (such as a power supply), for purposes of clarity.

The network-enabled device may comprise virtually any commercially-available portable or fixed communication device available in the market. In a typical embodiment, the device comprises a tablet computer or smart phone, but could also comprise a desktop or laptop computer, or any other computing device having network communication capabilities. Processor 300 provides general operation of the device by executing processor-executable instructions stored in memory 302, for example, executable code. Processor 300 typically comprises a general purpose processor, microprocessor, and/or microcontroller, selected using criteria such as power consumption, size, and computing power.

Memory 302 comprises one or more information storage devices, such as RAM memories, ROM memories, flash memories, and/or virtually any other type of electronic, optical, or mechanical memory device suitable in a portable application. Typically, memory 302 comprises more than one type of memory. For example, memory 302 may comprise a ROM memory used to store processor-executable instructions for operation of the device, plus RAM memory to store information as it is received from server 108.

Network interface 304 is electronically coupled to processor 300 and comprises electronic circuitry necessary for the device to communicate with server 108. Typically, network interface comprises well-known circuitry and firmware necessary to send and receive information sent via one or more commonly-used network protocols, such as the well-known TCP/IP suite of protocols. Alternatively, or in addition, communication network interface 304 could comprise electronics and supporting software/firmware to support a variety of well-known communication types, including Ethernet, Wi-Fi, Bluetooth, fiber-optic communications, and so on.

User interface 306 is coupled to processor 300 and is used to allow users to view the future sporting event information, pre-game questions, in-game questions, and other information received from server 108 via communication interface 304 and to enter pre-game and in-game predictions. User interface 306 may comprise one or more touchscreens, pushbuttons, switches, sensors, keypads, and/or microphones that generate electronic signals for use by processor 300 upon initiation by users. User interface 306 may additionally comprise one or more liquid crystal displays (LCDs), one or more light emitting diode displays (LEDDs), one or more light emitting diodes (LEDs), light arrays, or any other type of visual display. Further, user interface 306 could, alternatively or in addition, comprise an audio device, such as a speaker, for audible presentation of information to customers. Of course, the aforementioned items could be used alone or in combination with each other and other devices may be alternatively, or additionally, used. Typically, input device 306 comprises a widely-known touchscreen device capable of displaying information and receiving user input.

Payment device 308 allows users to pay for goods and services via the device. Payment device 308 may comprise a card reader, a camera, an RFID reader, a physical keypad, a virtual keypad displayed by user interface 306, or other device used to receive payment information from users. Payment information received from users is provided via network interface 304 to a payment processing center (not shown) or directly to a point-of-sale system associated with a particular venue that a user may be located.

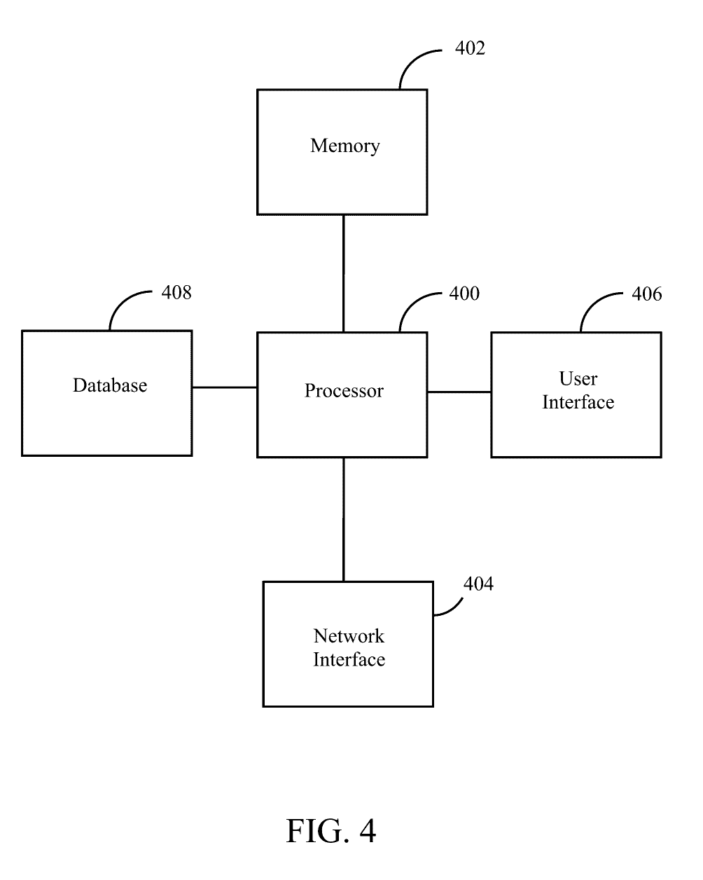

FIG. 4 is a functional block diagram of one embodiment of server 108. Specifically, FIG. 4 shows processor 400, memory 402, network interface 404, user interface 406, and database 408. It should be understood that not all of the functional blocks shown in FIG. 4 are required for operation of server 108 (for example, user interface may not be necessary), that the functional blocks may be connected to one another in a variety of ways, and that not all functional blocks necessary for operation of server 108 are shown (such as a power supply), for purposes of clarity.

Server 108 may comprise virtually any commercially-available servers on the market today, including the P4300IP server system manufactured by Intel Corporation of Santa Clara, Calif. Processor 400 provides general operation of any of the servers by executing processor-executable instructions stored in memory 402, for example, executable code. Processor 400 typically comprises a general purpose processor, such as any of the Xenon® family of processors manufactured by Intel Corporation of Santa Clara, Calif., although any one of a variety of microprocessors, microcomputers, and/or microcontrollers may be used alternatively.

Memory 402 comprises one or more information storage devices, such as hard drives, RAM memories, ROM memories, flash memories, and/or virtually any other type of electronic, optical, or mechanical memory device. Typically, memory 402 comprises more than one type of memory. For example, memory 402 may comprise a ROM memory used to store processor-executable instructions for operation of server 108, instructions for display of a website for offering sports-based rewards points to users, sports-based questions, predictions, point values, etc.

Database 408 comprises one or more information storage devices, such as hard drives, tape drives, RAID storage devices, and/or other high-volume, data storage devices. Database 310 is used primarily to store user account information, pre-game and in-game predictions received from users, and rewards points or credit information. It should be understood that various types of data can be stored either in database 408 or memory 402, depending on the selected system architecture.

Network interface 404 is electronically coupled to processor 400 and comprises electronic circuitry necessary for server 108 to communicate with sports server 112 and network-enabled devices. Typically, network interface 404 comprises hardware, software and/or firmware necessary to transmit and receive information sent via one or more commonly-used network protocols, such as the well-known TCP/IP suite of protocols. Alternatively, or in addition, communication interface could comprise electronics and supporting software/firmware to support other well-known communication types, including Wi-Fi, Bluetooth, wireless telephone communications, fiber-optic communications, and so on.

Optional user interface 406 is coupled to processor 400 and is used to allow an individual to control operation of server 108 and/or to receive information from the server. User interface 406 may comprise one or more pushbuttons, switches, sensors, keypads, keyboards, touchscreens, and/or microphones that generate electronic signals for use by processor 400 upon initiation by a user. User interface 406 may additionally comprise one or more seven-segment displays, a cathode ray tube (CRT), a liquid crystal display (LCD), one or more light emitting diode displays (LEDD), one or more light emitting diodes (LEDs), light arrays, or any other type of visual display. Further, the electronic display could alternatively or in addition comprise an audio device, such as a speaker, for audible presentation of information to a user. Of course, the aforementioned items could be used alone or in combination with each other and other devices may be alternatively, or additionally, used.

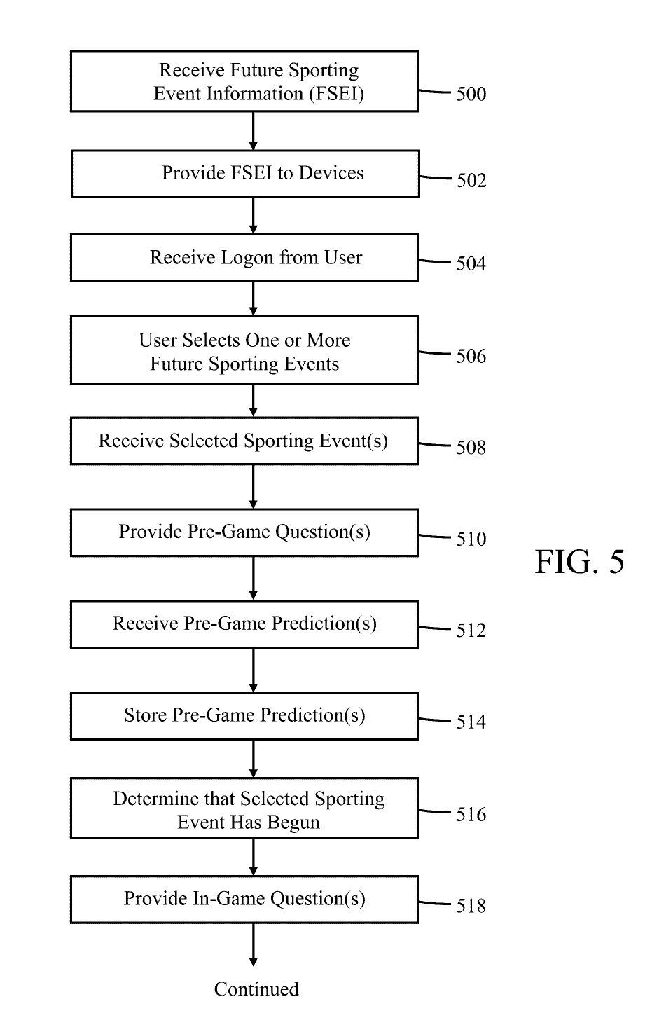

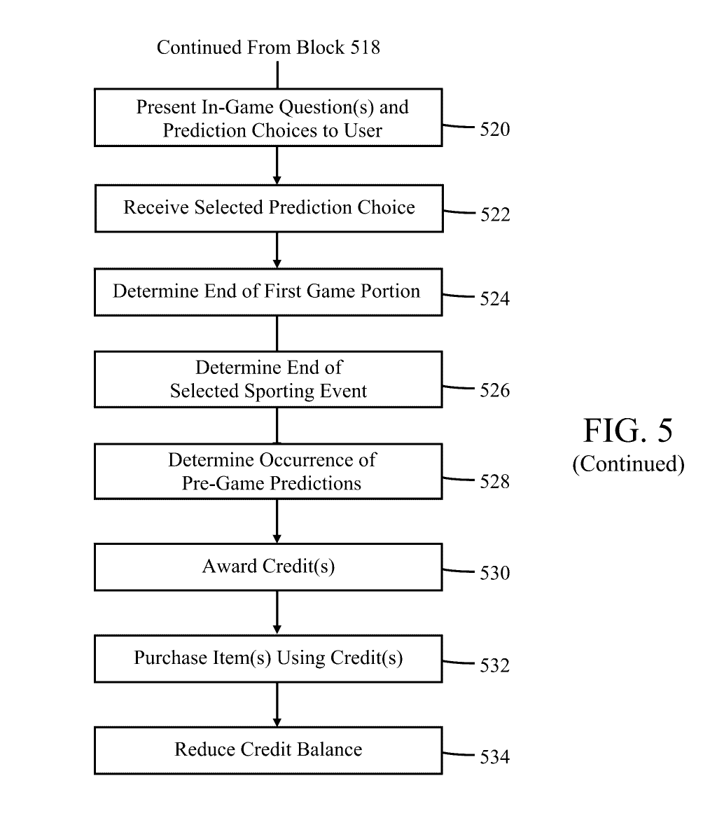

FIG. 5 is a flow diagram illustrating one embodiment for providing an interactive, sports-based rewards program to venues, as performed by server 108. Processor 400 within server 108 executes processor-executable instructions stored in memory 402 that causes the server 108 to perform certain functions. It should be understood that in some embodiments, not all of the steps shown in FIG. 5 are performed, and that the order in which the steps are carried out may be different in other embodiments. It should be further understood that some minor method steps may have been omitted for purposes of simplifying the description.

At block 500, server 108 receives sporting information from sports server 112. Sports server 112 comprises a sporting event information distribution center, or more generally a data collection and distribution center, typically owned and operated by a third party, that provides sporting information from a wide variety of different sports, to customers such as server 108. In one embodiment, processor 400 decodes XML files provided by sports server 112 to generate the future sporting event information. The future sporting event information may comprise future team match ups (e.g., a list of teams playing against each other) and other related information, such as team or individual player statistics (such as team standing, win/loss percentage, batting averages, completion percentages, average rushing yards per game, field goal percentages, etc.). The future sporting event information is generally stored in memory 402 and then provided to network-enabled devices upon request.

At block 502, processor 400 provides the future sporting event information via network interface 404 and wide-area network 110 to one or more network-enabled devices, either on a continuous basis or on demand by individual network-enabled devices. Such information is received by each network-enabled device via network interface 304. The future sporting event information may be displayed on a web page accessible by network-enabled devices or directly to network-enabled devices via an application running on the network-enabled devices. In one embodiment, the future sporting event information may also be provided to one or more public venues, where it may be displayed using one or more television monitors distributed within such venues. Patrons of the venues may see the future sporting event information, become interested in participating in the interactive sports-based rewards program, then participate in the interactive sports-based rewards program by visiting a web site offered by server 108 or an application that may be downloaded to users' network-enabled devices.

At block 504, a user may begin participation in the interactive sports-based rewards program by using his or her network-enabled device to log onto an account previously created by the user, or may create a new account if it is the user's first time participating in the sports-related rewards program. The user account may be stored in database 408 and/or elsewhere, such as in a database located at a venue where the user logs into his or her account. The presence of users at venues participating in the sports-related rewards program may be determined by server 108 by identifying which local-area network a user has utilize to communicate with server 108. Each venue may operate their own local-area network and provide network identification information pertaining to their networks to server 108, such as an IP address assigned to a local gateway located at each venue. User location may, alternatively or in addition, be determined by other techniques, such as a code password or code provided by each venue to their patrons, GPS, RFID, etc.

At block 506, after viewing the future sporting event information, a user of a network-enabled device may select one or more future sporting events (i.e., individual or team match-ups), typically by touching a touch-sensitive display screen on the user's network-enabled device. Each of the one or more sporting events selected by a user may be referred to herein as a “selected sporting event”. In one embodiment, users may only select a future sporting event if they are located at a venue that participates in the sports-related rewards program. In this embodiment, if a user attempts to select one of the future sporting events, a message may be displayed to the user indicating that the selection was rejected due to non-presence in a participating venue. In one embodiment, server 108 may provide a name and/or location of one or more participating venues near the present location of the user, if the user's present location has been determined using GPS or network identification means.

At block 508, the user's selection(s) is/are sent back to server 108 by processor 300 via network interface 304.

At block 510, in response to receiving the user's selection(s) at block 508, processor 300 at server 108 provides one or more “pre-game” questions to the user for each sporting event chosen prior to commencement of the selected sporting event(s). In one embodiment, pre-game questions are only provided to users located at a participating venue, as described above. Pre-game questions comprise questions posed to the user prior to commencement of a selected sporting event, i.e., before the start of a game between two teams or opponents, to predict certain outcomes related to the selected sporting event, either on a team level or individual level. Questions are pre-stored in memory 402 and may be grouped based on the type of sport that each question pertains. For example, questions relating to baseball may be stored in association with other baseball-related questions relating to baseball, while questions relating to football may be stored in association with other football-related questions. In one embodiment, processor 400 randomly chooses one of the questions based on the type of sport related to the selected sporting event. In other embodiments, a live operator may pre-select pre-game questions and store the selections in memory 402. In one embodiment, a set of pre-game questions may be selected from a plurality of pre-stored, pre-game questions, and/or the operator enter new, customized questions for storage in memory 402.

In one embodiment, each pre-game question is associated with two or more prediction choices presented by server 108, for example, multiple-choice predictions for the user to select. In other embodiments, the user may enter his or her own prediction to the pre-game question(s), e.g., in a free-text input format.

The pre-game questions are presented to the user via user interface 306 on the user's network-enabled device. The user enters his or her predictions to each pre-game question using user interface 306.

At block 512, the user's prediction(s) for each selected sporting event are sent to server 108 by processor 300 via network interface 304.

At block 514, server 108 receives the predictions sent at block 512 and processor 400 stores them in association with the user in the user's account or otherwise in association with the user who provided the predictions.

At block 516, at some later time, processor 400 determines that one of the selected sporting events has begun, by monitoring real-time sports-related information from sports server 112. The real-time sports-related information will generally indicate the start of each sporting event as it occurs in real or near-real time. In another embodiment, processor 400 determines that one of the selected sporting events has begun by monitoring the current date and time vs. an expected start date and time, received previously from sports server 112. The real-time sports-related information may be stored in memory 402 for later use in determining whether the pre-game predictions, as well as “in-game” predictions (explained below) selected by users actually occurred, as well.

At block 518, in response to determining that the selected sporting event has begun, processor 400 may provide one or more “in-game” questions to any user who has previously provided pre-game predictions for the selected sporting event. In another embodiment, the in-game questions may also be provided to other users who did not submit pre-game predictions, and/or to venues for display to their patrons via TV monitors or the like. The “in-game” questions are questions posed to users, asking users to predict an action that may occur during a first portion of the selected sporting event, such as an inning, half-inning, or a number of innings in a game of baseball, or during possession of a football (“drive”) by one team, a quarter, half, or even an entire game of football. In some cases, pre-game questions can be the same as in-game questions.

In one embodiment, in-game questions are only provided to users who are determined to be present at a participating venue, as described earlier.

In one embodiment, each in-game question is pre-assigned two or more prediction choices for users to select, and each prediction choice is assigned a point value that is generally proportional to the likelihood of a particular prediction occurring. In another embodiment, predictions are selected independently from each question by processor 400 on a dynamic basis. The likelihood may be based on historical statistical averages of teams and/or players prior to commencement of the selected sporting event (“pre-game statistics), and/or based on events or actions that occur as the selected sporting event is played (“in-game statistics”). For example, in baseball, the odds of a home run being hit during an inning by average players may be 1 in 25, and server 108 may assign a point value of “100” to a home run prediction. However, for a team having at least three players batting in the half-inning having higher-than-average home runs (either during a particular time period, such as a week, month, season, lifetime, number of games, etc.), the odds may increase to, say, 1 in 15. In this case, server 108 may take this information into account and associate a point value of only “75” to a home run prediction, reflecting the higher likelihood that one of these players will hit a home run. Thus, server 108 may take into account a number of factors when assigning point values to predictions, based on information available to server 108 from sports server 112. The point values may be adjusted as the game is being played as well, in some embodiments.

Processor 400 selects the in-game questions from memory 402, which stores a plurality of questions for each type of sport. Selection of questions and/or predictions may depend on how long a particular sporting event has been played, the score, a particular status of the sporting event, events that occur during the selected sporting event, or some other metric. For example, if a fumble occurs during a football game (thus staring a new “portion”), and the opposing team recovers the football on the 1 yard line, processor 400 will select a question based on the ball position and the increased likelihood that a score will occur. Thus, processor 400 may select a question such as, “Will Team X score a touchdown?” rather than, “Will Team X be forced to punt?”

Similarly, in one embodiment, processor 400 may provide two or more prediction choices for each question, depending on how long a particular sporting event has been played, the current score, a particular status of the sporting event, events that occur during the selected sporting event, or some other metric, rather than statically assigning prediction choices to questions. For example, in a game of football, if Team X is losing by more than 20 points in the fourth quarter, processor 400 may select a question such as, “What will happen during this drive?” and then assign two prediction choices based on the fact that Team X is losing by 20 points and the game is in the final quarter, such as, “Pass greater than 30 yards” and “Interception”. Both of these predictions are more likely to occur in a game where one team is losing by a large number of points and the game is in the final period of play.

In another embodiment, processor 400 may assign point values to each prediction choice based on in-game statistics as the game is being played, determined from the real-time sports-related information, such as how long a particular sporting event has been playing, the score at any point during the game, a particular status of the sporting event, events that occur during the selected sporting event (such as home runs, home runs hit by each player, touchdown passes thrown, fumbles, etc.), or some other metric. For example, in a baseball game, processor 400 may assign an initial point value to a prediction choice of a “Home Run” of 100 points. If player X has hit two home runs during the game (an “in-game statistic”), as determined by processor 400 evaluating the real-time sports-related information, and is due to bat in a new inning, processor 400 may ask, “What will happen this half inning?” and assign a point value of only 50 points to a prediction choice of “Home Run”, reflecting potentially a greater likelihood that the particular player will hit a home run.

Thus, question selection, prediction choice assignment and/or point assignment may be made dynamically by processor 400 as events occur during the selected sporting event.

At block 520, the question and prediction choices are presented to the user via user interface 306. In one embodiment, a count-down timer is displayed to allow users only a predetermined time limit to respond to such in-game questions, such as 30 seconds.

At block 522, the user selects one of the prediction choices and in response, processor 300 sends the selected prediction choice to server 108 via network interface 304 and wide-area network 110. Processor 400 at server 108 receives the selected prediction choice and stores it in association with the user who provided the selected prediction choice, in database 408.

At the conclusion of the game portion (i.e., inning, half-inning, possession, etc.), processor 400 determines how many times the selected prediction choice occurred for each user participating in the interactive sports-based rewards program, and awards “rewards points” or a credit to each user based on the number of times that the selected prediction choice occurred during the game portion. In another embodiment, a credit is awarded immediately each time after that a selected prediction choice occurs during the game portion. In one embodiment, the credit is based on an original point value of the prediction choice multiplied by a number of times that the selected prediction choice occurred during the game portion. The credit is stored in association with users in database 408.

At block 524, processor 400 determines that a first game portion has concluded, and that a second game portion has begun from the real-time sporting event information from sports server 112. For example, the first game portion could be a top half of a baseball game, and the second game portion could be the bottom half of the baseball game. In a football game, a first game portion could be the first possession of one team, and the second game portion could be the first possession of the other team. For each game portion, processor 400 may select questions, predictions and point values to the predictions and present these to users at the beginning of each game portion, as described above.

At block 526, processor 400 determines that the selected sporting event has ended, typically by monitoring the real-time sports-related information from sports server 112. The real-time sports-related information will generally indicate when the selected sporting event has ended.

At block 528, in response to determining that the selected sporting event has ended, processor 400 reviews the real-time sporting information stored in memory 400 to determine whether any of the pre-game predictions were accurately predicted by the user. For each user who submitted one or more pre-game prediction choices, processor compares the selected pre-game prediction to the stored real-time sporting information stored in memory 402 to determine whether the prediction actually occurred. For example, if a pre-game prediction was that Team X would win the game, processor 400 determines from the stored real-time sporting information whether Team X won the game or not.

At block 530, processor 400 awards rewards points or credits to each user who accurately predicted outcomes to the pre-game questions. The credits are stored in association with each user in database 408. In one embodiment, the credits are only redeemable at a venue where a user is located during play of the selected sporting event. An indication of the credits awarded to each user may be provided to each user via their respective network-enabled devices. In one embodiment, credits are only awarded when it is determined that a user is located at a venue that participates in the sports-related rewards program.

At block 532, a user located at a venue may decide to purchase goods or services from the venue where the user is located using the credits stored in his or her account. In one embodiment, only credits earned while at the venue are redeemable at the venue. The user's network-enabled device may display a number of items for purchase while at the venue. The user may select one or more of the items, then indicate whether to apply credits from the user's account to pay for the item(s) entirely or in part, or apply a coupon or other discount to the item(s). Such entry by the user is transmitted to server 108 and/or to a local-area network operated by the venue, and on to a point-of-sale system where the ordered item(s) may be presented to a waitperson, attendant, chef, cook, or other employee at the venue. For example, a list of food and beverage items could be displayed to the user, along with a number of credits to purchase each item. The user may select one or more items for purchase using the credits in the user's account by selecting one of the items via user interface 306, for example, “hot wings”. An order for hot wings is sent from the user's network-enabled device to server 108 and/or a local point-of-sale system associated with the venue via a local-area network. In the case of the order being sent to server 108, server 108 may send the order to the point-of-sale system associated with the venue so that the order may be filled. In either case, the order may be provided to kitchen employees, who prepare the order, as well as a waitperson to deliver the order to the user once it has been prepared by the kitchen employees.

At block 534, server 108 reduces the credits in the account associated with the user who ordered one or more items from the venue by an amount proportional to the amount needed to purchase the item(s) or by a coupon credit amount. Server 108 may receive in indication of the purchase via the user's network-enabled device as described at block 532, or it may be provided by the point-of-sale system at the venue where the user is located.

The methods or algorithms described in connection with the embodiments disclosed herein may be embodied directly in hardware or embodied in processor-readable instructions executed by a processor. The processor-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

Accordingly, an embodiment of the invention may comprise a computer-readable media embodying code or processor-readable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

We claim:

1. A server for implementing a sports-based reward program, comprising:
a communication interface for receiving future sporting event information and real-time sporting event information, the future sporting event information related to one or more sporting events that will occur in the future, and the real-time sporting event information relating to events that occur during one or more sporting events as the sporting events are being played;
a network interface for communicating with a plurality of network-enabled devices;
a database for storing an account related to one or more users of the network-enabled devices;
a memory for storing processor-executable instructions; and
a processor for executing the processor-executable instructions that cause the server to:
receive the future sporting event information via the network interface;
provide the future sporting event information to users of the plurality of network-enabled devices via the network interface;
receive a selected sporting event from one of the network-enabled devices, the selected sporting event chosen by the user from one of the one or more sporting events that will occur in the future;
in response to receiving the selected sporting event, provide a pre-game question to the network-enabled device via the network interface prior to commencement of the selected sporting event, the pre-game question related to an outcome of the selected sporting event;
receive a pre-game prediction to the pre-game question from the mobile device via the network interface, the pre-game prediction indicative of a prediction, by the user, of the outcome related to the pre-game question;
store the pre-game prediction in association with the user in the database;
receive the real-time sporting event information via the network interface as the one or more sporting events occur, including the selected sporting event;
determine whether the outcome of the selected sporting event matches the pre-game prediction from the user; and
provide a credit to an account associated with the user when the outcome of the selected sporting event marches the pre-game prediction, the credit for redemption by the user at a venue.

2. The server of claim 1, wherein the processor-executable instructions comprise further instructions that cause the server to:
determine, from the real-time sporting event information, that the selected sporting event has commenced; and
provide an in-game question to the network-enabled device via the network interface after determining that the selected sporting event has commenced, the in-game question relating to an event that may occur during a first portion of the selected sporting event.

3. The server of claim 2, wherein the first portion of the selected sporting event comprises a half of an inning of a baseball game.

4. The server of claim 2, wherein the portion of the selected sporting event comprises a possession of a football by one of two teams playing a game of football.

5. The server of claim 2, wherein the processor-executable instructions comprise further instructions that cause the server to:
determine, from the real-time sporting event information, that the first portion of the selected sporting event has concluded; and
provide a second in-game question to the network-enabled device via the network interface after determining that the first portion of the selected sporting event has concluded, the second in-game question relating to a second event that may occur during a second portion of the selected sporting event.

6. The server of claim 1, wherein the processor-executable instructions comprise further instructions that cause the server to:
determine at least two pre-game prediction choices for association with the pre-game question;
wherein the pre-game prediction comprises a selection of one of the at least two pre-game prediction choices.

7. The server of claim 6, wherein the processor-executable instructions comprise further instructions that cause the server to:
assign a point value to each of the at least two pre-game prediction choices;
wherein the credit is based on the point value.

8. The server of claim 2, wherein the processor-executable instructions comprise further instructions that cause the server to:
provide at least two in-game prediction choices to the network-enabled device along with the in-game question;
assign a point value to each of the at least two in-game prediction choices;
receive an in-game prediction to the in-game question, the in-game prediction comprising one of the at least two in-game prediction choices; and
determine a number of times that the event identified by the in-game prediction has occurred during the first portion;
wherein the credit is based on the point value and the number of times that the event has occurred during the first portion.

9. The server of claim 6, wherein the processor-executable instructions comprise further instructions that cause the server to:
assign an initial point value to each of the at least two pre-game prediction choices;
determine in-game statistics from the real-time sporting event information; and
alter the initial point value of at least one of the at least two pre-game prediction choices based on the in-game statistics to generate an altered point value;
wherein the credit is based on the altered point value.

10. The server of claim 5, wherein the processor-executable instructions comprise further instructions that cause the server to:
provide two or more in-game prediction choices associated with the second in-game question to the network-enabled device, each of the two or more in-game prediction choices assigned an initial point value;
evaluate the real-time sports-related information to determine in-game statistics related to the selected sporting event; and
alter the initial point value of at least one of the two or more in-game prediction choices based on the in-game statistics to generate an altered point value;
wherein the credit is based on the altered point value.

11. The server of claim 1, wherein the processor-executable instructions comprise further instructions that cause the server to:
store a set of pre-game questions in the memory, each pre-game question having a number of pre-game prediction choices assigned thereto, each of the potential responses assigned with an initial point value;
evaluate the real-time sports-related information to determine pre-game statistics related to the future sporting events; and
alter the initial point value assigned to at least one of the pre-game prediction choices based on the pre-game statistics.

12. The server of claim 1, wherein the processor-executable instructions comprise further instructions that cause the server to:
determine a location of the user; and
award the credit to the user only when the user is located at the venue.

13. The server of claim 1, wherein the processor-executable instructions comprise further instructions that cause the server to:
receive information relating to use of at least a portion of the credit by the user to purchase one or more items from the venue;
adjust the account to reflect the use of the at least a portion of the credit.

14. The server of claim 2, wherein the processor-executable instructions comprise further instructions that cause the server to:
determine at least two in-game prediction choices for association with the in-game question;
wherein the in-game prediction comprises a selection of one of the at least two in-game prediction choices.

15. The server of claim 14, wherein the processor-executable instructions comprise further instructions that cause the server to:
determine the point value based on one or more events that occur during the selected sporting event.

16. The server of claim 2, wherein the processor-executable instructions further comprise instructions that cause the server to:
select the in-game question based on one or more events that occur during the game.
